(19) United States
(12) Patent Application Publication
(10) Pub. No.: US 2011/0184803 A1
(43) Pub. Date: Jul. 28, 2011

(54) Increasing Advertiser Utility in Broad Match Auctions

(76) Inventors: Eyal Even-Dar, New York, NY (US); Seyed Vahab Mirrokni Banadaki, New York, NY (US); Shanmugavelayutham Muthukrishnan, New York, NY (US); Uri Nadav, Menlo Park, CA (US)

(21) Appl. No.: 13/012,300

(22) Filed: Jan. 24, 2011

Related U.S. Application Data
(60) Provisional application No. 61/297,552, filed on Jan. 22, 2010.

(51) Int. Cl. G06Q 30/00

(52) U.S. Cl. 705/14.48; 705/14.71; 705/14.54

(57) ABSTRACT

Methods, systems, and apparatus, including computer programs encoded on a computer storage medium, for increasing advertiser utility in broad match auctions. In one aspect, a method includes receiving, from an advertiser, a set of keywords; accessing a linear program for a keyword language auction; determining a solution to the linear program; determining, based on the solution to the linear program, a proper subset of the keywords that increases the advertiser's utility relative to the advertiser's utility for the set of keywords; and generating utility bids for each of the keywords in the subset, each utility bid corresponding to one of the keywords in the subset and being a bid price for the keywords.

### CROSS-REFERENCE TO RELATED APPLICATIONS

This application claims the benefit under 35 U.S.C. § 119(e) of U.S. Patent Application Ser. No. 61/297,552, entitled “Bid Optimization for Broad Match Ad Auctions,” filed Jan. 22, 2010, which is incorporated herein by reference in its entirety.

### BACKGROUND

This specification relates to increasing advertiser utility in broad match auctions.

Advertisement slots in web pages can be allocated to advertisers through an auction. For example, advertisers can provide bids specifying amounts that the advertisers are respectively willing to pay for presentation of their advertisements. In turn, an auction can be performed and the advertisement slots can be allocated to advertisers according to their bids, and, optionally, other auction parameters. For example, when one advertisement slot is being allocated in the auction, the advertisement slot can be allocated to the advertiser that has the highest auction score based on the bid and other parameters. When multiple advertisement slots are allocated in a single auction, the advertisement slots can be allocated to a set of bidders that have the highest auction scores.

Advertisement auctions in “sponsored search” may allocate to advertisers advertisement slots that are used to display advertisements with search results responsive to a search query. Generally, sponsored search includes a pay per click (“PPC”) Internet advertising model used on websites, for example, where advertisers pay a host when the advertiser's advertisement is clicked. In sponsored search, advertisers bid on a keyword or on keyword phrases (collectively referred to herein as a “keyword” or “keywords,” without limitation) that are relevant to a target market of the advertiser.

In an example, a searcher may submit a search query that includes keywords (e.g., search terms). In this example, an advertiser is interested in displaying advertisements that are relevant to the searched keywords. Accordingly, the advertiser bids on the keywords included in the search query. The search engine runs an auction in response to the searcher's query to determine the advertisements that will be shown to the searcher. In this example, the advertiser only pays if the searcher clicks on the advertiser's advertisement, under the PPC model. The amount paid by the advertiser for the advertisement is determined by the auction mechanism, but is no larger than a bid price submitted by the advertiser for the keywords.

Advertisement auctions may support an exact match of keywords. In an exact match, an advertisement is associated with keywords. The advertisement is displayed to a searcher when the searcher performs a search query that exactly includes the keywords associated with the advertisement. Advertisement auctions also support a broad match of keywords. Generally, a broad match includes a form of keyword matching in which an advertisement is matched with a keyword and with variations of the keyword (“variation keywords”) in any order. In an example, an advertiser wants to display advertisements for running shoes. In this example, the advertiser bids on the keyword “running shoes” in an advertisement auction. Using broad match, the advertisement auction generates variations of the keyword “running shows,” including, e.g., a derivative of the keyword (e.g., tennis shoes), a synonym of the keyword (e.g., running sneakers), a singular form of the keyword (e.g., running shoe), and a varied order of the keyword (e.g., shoes running).

The advertisement auction applies an advertiser's bid for keywords to variation keywords generated in a broad match. When an advertiser's bid is applied to variation keywords, the advertiser may be bidding on some keywords that result in a high profit (e.g., utility) for the advertiser and other keywords that result in a low profit to the advertiser. However, because the advertiser is not able to control which variation keywords receive the advertiser's bid, the advertiser is not able to control the advertiser's total profit from bidding on a keyword.

In an example, the advertiser bids $5.00 on the keyword “running shoes.” If the advertiser bids on the keyword “running shoes” as a broad match, then the advertiser's bid of $5.00 is also applied to the variation keywords. A bid of $5.00 for the keyword “running shoes” and some variation keywords (e.g., running sneakers and shoes running) may return a relatively high value for the advertiser, for example, when the advertiser displays an advertisement for cross-training running shoes. However, a bid of $5.00 on the variation keyword “tennis sneakers” may return a relatively low value for the advertiser for the cross-training running shoes advertisement.

### SUMMARY

This specification describes technologies relating to increasing advertiser utility in broad match auctions.

In general, one innovative aspect of the subject matter described in this specification can be embodied in methods that include the actions of receiving, from an advertiser, a plurality of targeting criteria, with each of the targeting criteria at least partly specifying a keyword selected by the advertiser; accessing, based on the plurality of targeting criteria, a set of keywords, with the set of keywords including base keywords that are derived from the targeting criteria and variation keywords that are derived from the base keywords; for each keyword in the set of keywords: retrieving a value for the advertiser of an advertisement click-through of an advertisement that is displayed in response to a query that includes the keyword; retrieving a cost for a click-through of the advertisement; and retrieving an expected number of views of the advertisement; generating a utility score for the keyword, the utility score at least partly based on the value of the advertisement, the cost for the click-through of the advertisement, and the expected number of views of the advertisement; determining, based on the utility scores of the set of keywords, a proper subset of the keywords that increases the advertiser's utility relative to the advertiser's utility for the set of keywords; and generating utility bids for each of the keywords in the subset, each utility bid corresponding to one of the keywords in the subset and being a bid price for the keyword.

Implementations of the disclosure may include one or more of the following features. In some implementations, the method also includes receiving, from the advertiser, a budget; for each keyword in the set of keywords: determining a cumulative cost value according to the cost of the click-through of the advertisement and the expected number of views of the advertisement; and generating the utility bids such that an aggregation of cumulative cost values for the subset of the keywords is less than the budget. In other implementations, the query is a search query and the utility bid is a bid price for an advertisement slot displayed following the search query. In some implementations, the increased utility of the advertiser is a maximized utility of the advertiser. In yet other implementations, the utility bid equals the cost per click of the query.

In other implementations, the set of keywords is at least partly defined based on a bidding language, with the bidding language specifying whether the set of keywords includes a complete set of keywords in the advertisement auction or a subset of the keywords in the advertisement auction. In still other implementations, the method includes generating an approximation of the utility of the advertiser for the subset of keywords; and determining that the subset of keywords increases the utility of the advertiser.

In another aspect of the disclosure, a computer-implemented method for setting bids on queries in a broad match auction includes receiving, from an advertiser, a set of queries; accessing a linear program, with a fractional solution of the linear program being the same as an integral solution of the linear program; determining the fractional solution of the linear program; determining, based on the fractional solution of the linear program, a proper subset of the queries that increases the advertiser's utility relative to the advertiser's utility for the set of queries; and generating utility bids for each of the queries in the subset, each utility bid corresponding to one of the queries in the subset and being a bid price for the query.

In some implementations, the method also includes generating, from the set of queries, a weighted flow graph including a plurality of vertices and a plurality of edges, with at least some of the vertices corresponding to a query in the set of queries, with each of the edges corresponding to a weighed value score for two vertices, with one of the vertices in the plurality of vertices including a source node that is connected to other vertices having a first pre-defined edge weight, and with another one of the vertices in the plurality of vertices including a target node that is connected to other vertices having a second pre-defined edge weight; and partitioning the graph into two sides, with one side of the graph including the source node and with another side of the graph including the target node, and with the side of the graph including the target node including the proper subset of queries that increases the advertiser's utility relative to the advertiser's utility for the set of queries.

In still another aspect of the disclosure, a computer-implemented method for setting bids on keywords in a broad match auction includes receiving, from an advertiser, a set of keywords; accessing a linear program for a keyword language auction; determining a solution to the linear program; determining, based on the solution to the linear program, a proper subset of the keywords that increases the advertiser's utility relative to the advertiser's utility for the set of keywords; and generating utility bids for each of the keywords in the subset, each utility bid corresponding to one of the keywords in the subset and being a bid price for the keywords. In some implementations, the solution includes a fractional solution, and determining the proper subset of the keywords is at least partly based on rounding the fractional solution to an integral solution in accordance with a probability of the fractional solution being an integer.

Other embodiments of the foregoing aspects include corresponding systems, apparatus, and computer programs, configured to perform the actions of the methods, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual diagram of an environment in which a bid generator is used to increase advertiser utility in broad match auctions.

FIG. 2 is a flow chart of a process for increasing advertiser utility in broad match auctions.

FIG. 3 is a flow chart of a process for increasing advertiser utility in broad match auctions using the query language.

FIG. 4 is a flow chart of a process for increasing advertiser utility in broad match auctions using the keyword language.

Like reference numbers and designations in the various drawings indicate like elements.

### DETAILED DESCRIPTION

### §1.0 Overview

An advertiser targets advertisement campaigns to queries of a searcher by determining a set (“S”) of queries that are of interest to the advertiser. The criteria for choosing S is for the advertiser to pick a set of keywords that searchers may use in a query when looking for products of the advertiser. An advertisement auction system may use a broad match technique to generate S, for example, by matching the advertiser's keywords with variation keywords. In an example, the advertiser chooses the keyword “tennis shoes.” A searcher searching for this keyword may use a singular form or plural forms of the keyword, synonyms of the keyword, related keywords (e.g., “clay court footwear”), misspellings of the keyword (e.g., “tens shoe”), extensions of the keyword (e.g., “white tennis shoes”), and a reordering of the keyword (e.g., “shoes lawn tennis”). Additionally, searchers may also search using words not found in the keyword (e.g., “Wimbledon gear,” “US Open Shoes,” and “hard court soles”). In this example, these variations of the keyword “tennis shoes” are of interest to the advertiser, and the advertiser would like to bid on these variations of the keyword “tennis shoes.” The advertisement auction system may implement a broad match technique to make advertisers eligible on the variations of the keyword “tennis shoes” by generating S that includes the variations of the keyword tennis shoes.

The advertisement auction system may also generate a proper subset of S such that an advertiser's bids on the keywords in the subset of S increases (e.g., maximizes and/or optimizes) a utility of the advertiser relative to S. In a broad match auction for search queries, an advertiser's bid for a keyword in S is applied to queries including the keyword and to queries including variations of the keyword. The advertisement auction system determines a corresponding bid price for each of the keywords in the subset of keywords that increases the advertiser's utility, relative to S, of being assigned queries including both the keywords and the variation keywords. The bid price that is determined may vary from the bids specified by the advertiser.

### §1.1 Example Environment

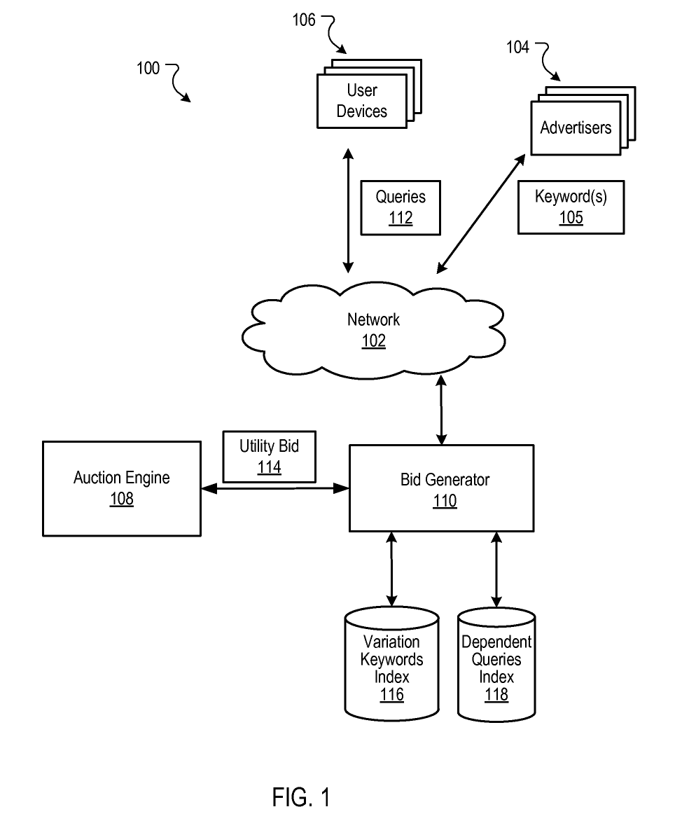

FIG. 1 is a conceptual diagram of an environment 100 in which a bid generator 110 is used to increase advertiser utility in broad match auctions. The environment 100 includes network 102, e.g., a local area network (LAN), a wide area network (WAN), the Internet, or a combination of them, that connects advertisers 104, user devices 106, auctions 108 and bid generator 110.

The advertiser 104 includes a person, collection of people, or other entity who wishes to make information available to an audience. An advertisement is a vehicle through which the advertiser brings the information to the audience. For example, advertisers can include retailers selling particular products, and an advertisement can include a description of one or more of the products.

Advertiser 104 submits keywords 105 to bid generator 110 through network 102. Variation keywords include variations of keywords 105 that are generated by bid generator 110 during a broad match auction. Environment 100 stores variation keywords in variation keywords index 116. In an example, keywords 105 are also stored in an index, or other data repository, including, e.g., variation keywords index 116.

Queries 112 include searches for particular keywords 105 that are performed over network 102. In an example, a query includes words or phrases submitted by a user in a search. In contrast, a keyword includes words selected by an advertiser as relevant to an advertisement of the advertiser. Environment 100 also includes dependent queries, including, e.g., searches for variation keywords, as described in further detail below. Generally, a dependent query includes a query that is related to the contents (e.g., the keywords) of another query. Environment 100 stores dependent queries in dependent queries index 118. Additionally,

User device 106 includes an electronic device that is under control of a user (e.g., a searcher) and is capable of sending queries 112 (e.g., search queries) over network 102. Example user devices 106 include personal computers, mobile communication device, and other devices that can send and receive data over the network 102. User device 106 typically includes a user application, e.g., a web browser, to facilitate the sending and the receiving of data over network 102.

Auction engine 108 includes a mechanism in which queries 112 are matched with bids for keywords 105. In particular, queries 112 include keywords 105. Auction engine 108 Fassigns advertisement slots to advertisers 104 by determining an advertiser 104 that has a maximum auction score for keywords 105 included in queries 112. As used herein, the maximum auction score is also referred to as a “winning bid” or “maximum bid” or “maximum amount.” However, the winner of an auction may not, in fact, have submitted the highest bid, as other auction parameters may result in a lower bid winning the auction. These other auction parameters include quality scores that measure the quality of an advertisement or a landing page to which the advertisement links to, a relevance match that measures the relevance of the advertisement to the subject matter of a web page or search query, and other parameters.

Bid generator 110 is an electronic device that is configured to determine utility bid 114. Generally, utility bids 114 include bids for a subset of keywords 105 that increases an advertiser's utility of winning queries 112 related to a subset of keywords 105 in a broad match auction. In particular, the advertiser's utility for the subset of keywords is increased relative to the advertiser's utility of winning queries 112 related to keywords 105, including, e.g., a complete set of keywords. In an example, bids for keywords 105 include various dollar amounts advertiser 104 is willing to spend to “win” auctions on queries 112 including certain keywords 105. Generally, a win of an auction on a query 112 refers to an advertiser being assigned an advertisement slot that is auctioned in response to the query 112, for example, because the advertiser is the highest bidder or has the highest auction score for the advertisement slot.

In a broad match auction, a bid for keyword 105 may also be applicable to a set of variation keywords, for example, when variations of keyword 105 are generated in the broad match auction. In this example, the bid for keyword 105 may result in advertiser 104 winning an auction, including, e.g., query 112 including keyword 105 and a set of dependent queries based on the set of variation keywords. In this example, bid generator 110 is configured to determine utility bid 114 that increases the utility of advertiser 104 from the auction. In particular, bid generator 110 determines a set of queries that increases (e.g., maximizes) the advertiser's utility, for example, relative to a utility of the advertiser winning another set of queries resulting from keyword 105.

Bid generator 110 can be any of a variety of computing devices capable of receiving information, such as a server, a distributed computing system, one or more servers, and so forth. Bid generator 110 may be a single server or a group of servers that are at a same location or at different locations.

In an example, bid generator 110 is configured to generate utility bid 114 based on keyword 105 and on the variations of keyword 105. In this example, each query q in queries 112 has a value v(q) per click for advertiser 104. The expected price per click is represented by c(q) and n(q) represents the expected number of clicks for an advertisement. c(q) and n(q) include statistical estimates provided by search engines. Bid generator 110 is configured to determine utility bids 114 for a subset of keywords 105 to maximize expected utility, e.g., Σ_{q} (v(q)−c(q))n(q), for an advertiser 104 relative to the advertiser's utility for the complete set of keywords 105.

In a variation of FIG. 1, advertisers 104 may submit to bid generator 110 queries (not shown), for example, in a query language in which an advertiser 104 bids directly on queries, as described in further detail below. In this example, bid generator 110 is configured to use queries received from advertisers 104 in generating utility bids 114.

In another variation of FIG. 1, advertisers 104 may submit to bid generator 110 targeting criteria (not shown). In this example, targeting criteria includes queries, one or more keywords and/or one or more keywords that are relevant to a target market of the advertiser, bids, and so forth.

### §1.2 Dependent Queries

Bid generator 110 is configured determine utility bid 114 based on dependent queries (e.g., which include variation keywords). Generally, dependent queries include queries that are generated by advertiser 104 biding on keyword 105 for query 112, e.g., query q and broad matches to keywords in the query q. As a result of a broad match, the bid may also apply to a dependent query (“query q′”). Query q′ includes variations of the keywords in query q. Advertiser 104 has different values v(q) and v(q′) on queries q and because users for queries q and q′ differ on their intentions and therefore on their respective values to advertiser 104. In an example, advertiser 104 may generate a positive profit (e.g., utility) on query q and a negative profit on query q′. In this example, advertiser 104 may bid on query q. However, by bidding on query q, the advertiser is forced to implicitly bid on query q′ as well. Bid generator 110 is configured to generate utility bid 114 that increases the positive profit of bidding on queries 112, relative to the profit of bidding on other queries, while decreasing the negative profit of bidding on dependent queries.

### 2.0 Generating a Model to Determine a Utility Bid

In an example, advertiser 104 is interested in showing an advertisement to users (e.g., searchers) after they search for queries 112 from a set of queries (hereinafter “Q”) that include at least some of keywords 105. Advertiser 104 derives utility from having a user click on an advertisement. In this example, clicks associated with different queries may have different utilities to advertiser 104. Advertiser 104 has a value of v(q) (e.g., units of monetary value) associated with a “click” that follows query 112, including, e.g., query q ∈ Q. The advertiser's value v(q) is known to the advertiser, for example, by the advertiser performing statistical analysis to determine a number of clicks leading to a sale, a profit for a sale, an estimated value per click, and so forth.

In this example, prices of clicks are posted and the search volume of every query as well as its click through rate (e.g., a probability that users would click an advertisement) are known to advertiser 104, for example, for the advertiser's advertisements. Every query q is associated with a pair of parameters, namely (c(q),n(q)), where c(q) is the per click cost of query q, and n(q) is the expected number of clicks that would result from winning query q. In this example, the expected number of clicks is determined from the search volume of query q and the advertiser's specific click through rate for query q. Thus, when an advertiser wins a query q, the overall utility from winning, denoted w(q), is w(q)=(v(q)−c(q))n(q). Accordingly, bid generator 110 is configured to determine utility bids 114 for keywords 105 (or a subset of keywords 105) to increase expected utility, e.g., Σ_{q} (v(q)−c(q))n(q), for an advertiser 104, for example, relative to a utility that an advertiser would derive from bidding on other keywords and/or other or larger sets of keywords.

### §2.1 Bidding Languages

A bidding language is a way for an advertiser 104 to specify a willingness to pay for queries 112. A selection of a bidding language determines how advertiser 104 bids in auction 108. Bidding languages may include a query language and a keyword language, each of which are described below.

### §2.2 Query Language

A query language is a bidding language in which advertiser 104 can specify a bid for every query 112, e.g., query q, as a broad match. To promote an accurate description of an advertiser's value per query 112, bid generator 110 lets advertiser 104 specify all possible queries 112 with exact or broad match, and a monetary bid for each of queries 112. If an advertiser is allowed to bid on each type of query 112 as an exact match as well as broad match, the advertiser can choose a value for each query 112 that is independent of a value assigned to the other queries 112.

### §2.3 Keyword Language

The keyword language allows advertisers 104 to place a bid for keywords 105, rather than directly on queries 113. As previously described, a query may include keywords, in addition to other words that are not keywords. In an example, an advertiser selects the keyword “running shoes,” because this keyword is relevant to the advertiser's advertisement for running shoes. A relevant query may include only the keywords “running shoes.” However, a relevant query may also include keywords and non-keywords, e.g., “cheap running shoes.” As described herein, an advertiser may bid on keywords and/or may bid on queries.

In the keyword language, because advertisers 104 bid on keywords, advertisers 104 effectively bid on a subset of queries 112 (“S ⊂ Q”). A query 112 in S ⊂ Q is represented as “s” and accordingly s ∈ S. An advertiser may also specify s is to be matched exactly or broadly.

### §2.4 The Auction

A bid (e.g., b ∈ [symbol] ^{|Q|} in a bidding language is associated with a set of winning queries denoted by φ(b)={q ∈ Q|b(q)≧c(q)}. A subset of queries that is a winning set of some bid b is referred to as a feasible winning set, and is denoted by “T.” The utility associated with a feasible winning set T is

$$u ( T ) = {\sum }_{q ∈ T} ( v ( q ) - c ( q ) ) n ( q ) ,$$

where v(•) and n(•) are advertiser specific.

For query 112, bid generator 110 determines utility bid 114 of advertiser 104. For the queries that the advertiser has not bid on directly, but only implicitly through a broad match framework, bid generator 110 computes an appropriate bid for advertiser 104 to participate in auction 108. This bid may differ from the bid on the underlying keyword on which the advertiser has bid.

In an example, bid generator 110 computes a bid for query 112 by aggregating the bids for all keywords 105 included in query 112. In this example, when query 112 (e.g., query q) matches keywords w₁, . . . , wₖ from the advertiser list of phrases (e.g., keywords 105), the bid for the query q is interpreted as b(q)=maxᵢb(wᵢ) (e.g., using a maximum aggregation operator).

Given that b(q)=maxᵢb(wᵢ), bid generator 110 may be configured to determine utility bids 114 for a set of keywords such that bids (e.g., b(q)) for the queries including the subset of keywords increases the advertiser's utility of winning the queries, for example, relative to the advertiser's utility of winning other queries including a different set of keywords. In another example, bid generator 110 may be configured to determine utility bid 114 for a query itself, for example, when auction 108 is conducted in the query language. The techniques described herein for generating a utility bid for a query are equally applicable to generating a utility bid for a keyword, and vice versa.

In an example, bid generator 110 determines utility bid 114 given advertiser's specific data (e.g., a set of queries Q, a value for queries v, a search volume and click through rates n(•)) and a bidding language [symbol] . In particular, utility bid 114 (e.g., b*) includes a feasible bid in the language [symbol] that increases the advertisers' utility from winning a set φ(b) of queries, relative to the advertiser's utility of winning a different set of queries, as represented by relationship (1).

b* ∈ arg max_{b⊂L}{u(φ(b))} (1)

As previously described, query q depends on a query q′ if winning query q′ implies winning query q. In the broad match auction in which the bid interpretation strategy is done using the maximum aggregation operator, query q depends on a query q′ if query q matches query q′ broadly, and the cost c(q) of query q is less than that of c(q′). In particular, if a bid b wins query q′, then b(q′)≧c(q′), but the interpreted bid for query q is then at least b(q′)Δc(q) since c(q′)≧c(q), hence the bid b must be winning query q as well. As a result, the cost structure incurs a set of pairs (q′, q), where the first entry of each pair q′ ∈ S is a valid keyword in the bidding language and the second entry is a valid query in the set of queries Q such that winning query q′ implies winning query q. This set of pairs is denoted by C, represented by relationship (2).

C={(q′, q)|q′ ∈ S, q ∈ Q, q matches q′ broadly, c(q)≧c(q)} (2)

### §2.5 Example Process

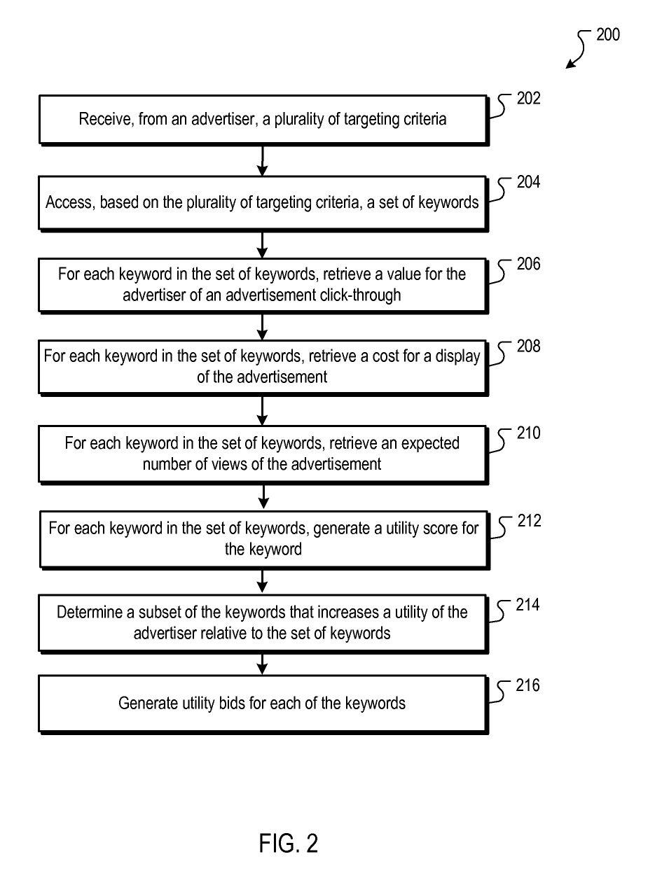

FIG. 2 is a flow chart of a process 200 for increasing advertiser utility in broad match auctions. In operation, bid generator 110 receives (202) from advertiser 104 a plurality of targeting criteria, including, e.g., keywords 105. Bid generator 110 accesses (204), based on the plurality of targeting criteria, a set of keywords, including, e.g., keywords stored in variation keywords index 116. For each keyword in the set of keywords, bid generator 110 retrieves (206) a value (e.g., v(q)) for advertiser 104 of an advertisement click-through. For each keyword in the set of keywords, bid generator 110 retrieves (208) a cost (e.g., c(q)) for a click of the advertisement. For each keyword in the set of keywords, bid generator 110 retrieves (210) an expected number of views (e.g., n(q)) of the advertisement. For each keyword in the set of keywords, bid generator 110 generates (212) a utility score for the keyword, for example, by calculating (v(q)−c(q)) n(q). Bid generator 110 determines (214) a subset of the keywords that increases a utility (e.g., Σ_{q} (v(q)−c(q))n(q)) of the advertiser relative to the advertiser's utility for the set of keywords. Bid generator 110 generates (216) utility bids for each of the keywords in the subset, using the techniques described below.

### 3.0 Bidding in the Query Language

As previously described, the query language allows placing bid 105 on every query 112. In the query language, computation of utility bid 114 may be equivalent to computation of an increased utility winning set. In an example, given an increased utility winning set T, utility bid 114 includes bid b(q)=c(q), for every query q ∈ T with positive utility and utility bid 114 includes bid b(q)=0 otherwise. In this example, a bid b derived from the increased utility winning set T, as described above, is utility bid 114.

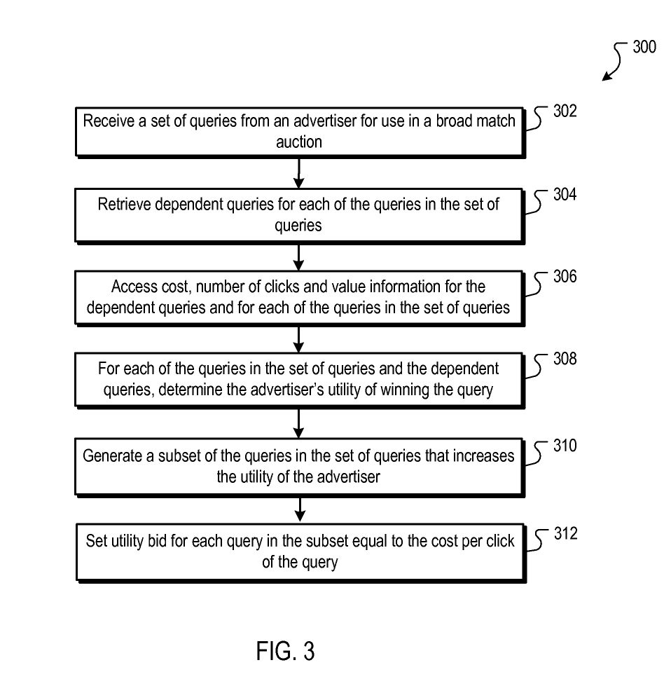

FIG. 3 is a flow chart of a process 300 for generating the utility bid 114 in the query language. In operation, bid generator 110 (FIG. 1) receives (302) a set of queries from advertiser 104 for use in broad match auction 108. Bid generator 110 retrieves (304) dependent queries (e.g., from dependent queries index 118) for each of the queries in the set of queries. Bid generator 110 may add the dependent queries to the set of queries. Bid generator 110 accesses (306) cost (e.g., c(q)), number of clicks (e.g., n(q)) and value information (e.g., v(q)) for the dependent queries and for each of the queries in the set of queries. Bid generator 110, for each of the queries in the set of queries and the dependent queries, determines (308) the advertiser's utility of winning the query. Bid generator 110 generates (310) a subset of the queries in the set of queries that increases the utility of advertiser 104 relative to the advertiser's utility for the set of queries. Bid generator 110 sets (312) the utility bid for each query in the subset equal to the cost per click (e.g., c(q)) of the query.

In an example, the subset of the queries is generated using a linear program (“LP”). In this example, the LP includes an integral LP represented by relationship (3).

$$\begin{matrix}ILP & ⋮ & max {\sum }_{{q}_{i} ∈ Q} {X}_{{q}_{i}} w ( {q}_{i} ) \\ For every pair ( {q}_{j} , {q}_{i} ) ∈ C & ⋮ & {X}_{{q}_{i}} - {X}_{{q}_{j}} \geq 0 \\ ∀ {q}_{i} ∈ Q & ⋮ & {X}_{{q}_{i}} ε \{ 0 , 1 \}\end{matrix} \qquad ( 3 )$$

In relationship (3), for every query q, an integral variable X_{q} is a 0-1 variable that is equal to 1 if query q belongs to the winning set of queries. In an example, bid generator 110 is configured to solve the integral LP by modifying the integral LP to an LP, in which X_{q} includes variables with values between 0 and 1 (0≧X_{q}≧1), rather than integer 0-1 variables In this example, bid generator 110 determines the utility bid 114, including, e.g., solution X* in which all the values are integer X*_{q} ∈ {0, 1} for all q ∈ Q.

In an example, bid generator 110 may be configured to implement a “minimum-cut” technique to decrease an amount of time required to compute utility bid 114 for queries 112. Generally, a minimum-cut of a graph includes a partition (e.g., cut) of the graph such that a cutset includes a smallest number of elements (e.g., in an unweighted graph) or a smallest sum of weighted elements (e.g., in a weighted graph). In this example, bid generator 110 computes a minimum-cut of a graph such that S, T (e.g., wherein S represents a subset of queries Q and T represents the increased utility winning set) represent the two sides of the cut. In this example, t ∈ T, where t represents a query in T. Bid generator 110 is further configured to determine an increased utility winning set by returning the set of queries that are on the same side of the cut as t in the graph. The utility bid 114 may be determined for a query in the increased utility winning set by setting utility bid 114 equal to the cost of the query.

### §4.0 Bidding in the Keyword Language

In the keyword language, advertiser 104 (FIG. 1) may only bid on keywords, rather than bidding on queries directly as in the query language. In particular, advertiser 104 may be restricted to bid on a proper subset of queries S ⊂ Q and the broad match technique implicitly derives bids for dependent queries. Because advertiser 104 does not bid on every query and thus the set of bids for queries is unknown, a use by bid generator 110 of a linear or polynomial-time algorithm to compute an optimal bid price may be computationally inefficient. In this example, bid generator 110 is configured to generate an approximation of an advertiser's utility, for example, using a constant-factor approximation technique, for a subset of queries that are based on the keywords selected by the advertiser. Based on the subset of queries that is approximated to increase the advertiser's utility relative to the set of queries, bid generator 114 determines utility bids 114 for keywords 105 belonging to the set of queries.

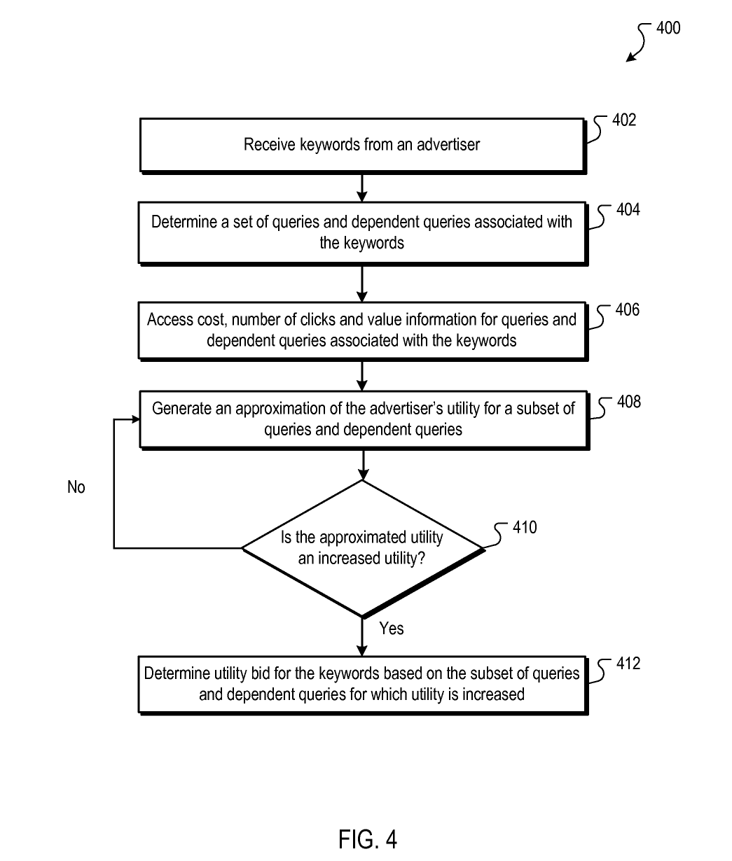

FIG. 4 is a flow chart of a process 400 for generating utility bid 114 in the keyword language. In operation, bid generator 110 receives (402) keywords 105 from advertiser 104. Bid generator 110 determines (404) a set of queries and dependent queries associated with the keywords. Bid generator 110 accesses (406) cost information (e.g., c(q)), number of clicks information (e.g., n(q)) and value information (e.g., v(q)) for the queries and the dependent queries. Bid generator 110 generates (408) an approximation of the advertiser's utility for a subset of the queries and dependent queries. Bid generator 110 determines (410) whether the approximated utility for the subset is an increased utility over the advertiser's utility for winning another set of queries, for example, using the constant factor approximation technique as described herein. If the approximated utility for the subset is not an increased utility over the advertiser's utility for winning another set of queries, then bid generator 110 repeats action 408. If the approximated utility for the subset is an increased utility over the advertiser's utility for winning another set of queries, then bid generator 110 determines (412) utility bids 104 for the keywords based on the set of queries and dependent queries for which utility is increased, for example, using the rounding to an integral solution technique as described herein.

In a variation of FIG. 4, actions 404, 406, 408, 410 and 412 are performed for keywords and variation keywords, rather than for queries and dependent queries. In the example of FIG. 4, the keywords are the keywords received from advertiser 104 in action 402. The variation keywords are variations of the keywords received from advertiser 104 in action 402. Additionally, bid generator 110 generates an approximation of the advertiser's utility for a subset of the keywords and variation keywords Bid generator 110 determines whether the approximated utility for the subset is an increased utility over the advertiser's utility for winning another set of keywords, for example, using the constant factor approximation technique as described herein. If the approximated utility for the subset is not an increased utility over the advertiser's utility for winning another set of keywords, then bid generator 110 repeats action 408. If the approximated utility for the subset is an increased utility over the advertiser's utility for winning another set of keywords, then bid generator 110 determines utility bids 104 for the keywords for which utility is increased, for example, using the rounding to an integral solution technique as described herein.

### §4.1 A Constant-Factor Approximation

In an example, bid generator 110 may be configured to implement a constant-factor approximation technique when the utility of a query exceeds the cost of the query (e.g., the cost part of the optimal utility is less than 1/c of the value part of the optimal utility, for some constant c>1). D(q)={q′|q′∈S, (q′, q) ∈C}. In this example, the constant-factor approximation technique provides a constant-factor approximation if for any query q ∈ Q\S, |D(q)| is less than a constant c′.

In an example, the constant-factor approximation technique may be applied when each query q ∈ Q is in the broad-match set of at most two queries q₁, . . . , q_{c′} ∈ S (e.g., for a constant c′). In this example, |D(q)|≦2 for any query q ∈ Q and E={c(q)|q ∈ Q}. The constant-factor approximation technique includes an integer linear program, as represented in relationship (4).

$$\begin{matrix}ILP - Approx max & {\sum }_{s ∈ S} ( {Z}_{s}^{c ( s )} + {R}_{s} ) {w}_{s} + {\sum }_{q ∈ Q \backslash S} {Y}_{q} {w}_{q} \\ ∀ q ∈ Q \backslash S , ( s , q ) ∈ C , ( r , q ) ∈ C & {Y}_{q} \leq {Z}_{s}^{c ( q )} + {Z}_{r}^{c ( q )} \\ ∀ q ∈ Q \backslash S , ( s , q ) ∈ C & {Y}_{q} \leq {Z}_{s}^{c ( q )} \\ ∀ s ∈ S , p , {p}^{′} ∈ E & {Z}_{s}^{p} = {\sum }_{t ∈ E , t \leq p} {Y}_{q} {W}_{s}^{t} \\ ∀ s ∈ S , p ∈ E & {Z}_{s}^{p} = {R}_{s} \leq 1 \\ ∀ q ∈ Q \backslash S & {Y}_{q} ∈ \{ 0 , 1 \} \\ ∀ s ∈ S & {R}_{s} ∈ \{ 0 , 1 \} \\ ∀ s ∈ S , p ∈ E & {W}_{s}^{p} , {Z}_{s}^{p} ∈ \{ 0 , 1 \}\end{matrix} \qquad ( 4 )$$

### Where,

Wₛ^{p} for any s ∈ S is the indicator variable corresponding to the bid of p on query s (e.g., as a broad match),
Zₛ^{p} for any s ∈ S is the indicator variable corresponding to the bid of at most p on query s (as a broad match),
Rₛ for any s ∈ S is the indicator variable corresponding to the exact match bid on query s, and
Y_{q} for any q ∈ Q\S is the indicator variable corresponding to a winning query q (as a result of bidding on queries in S).

In an example, bid generator 110 is configured to modify the integer 0-1 variables in relationship (4) to fractional variables between zero and one, and to compute a utility fractional solution for relationship (4) based on the fractional variable. In this example, utility fractional solution for relationship (4) includes a utility for a set of queries that is increased relative to the advertiser winning another set of queries. Bid generator 110 is configured to round the fractional solution to relationship (4) to generate a bidding strategy, as described in further detail below.

### §4.2 Rounding to an Integral Solution

In an example, relationship (4) is used to determine a fractional solution for utility bid 114 for query 112. The fractional solution may be represented as “V, Z, W, Y,” where V represents a vertex set in a weighted flow graph G, which is generated from the input of bids on queries 112. In particular, the vertex set of G is V={s, t} ∪ Q⁺ ∪ Q⁻where s is a source node, t is a target node and Q⁺ and Q⁻ are the sets of queries with positive/non-positive weights respectively, e.g., Q⁺≡{q|w(q)>0}. The source vertex s is connected to each vertex q ∈ Q⁻ with an edge of weight |w(q)|=|(v(q)−c(q)n(q)|. The target vertex t is connected with each vertex p ∈Q⁻, and p ∈ Q⁺ are connected with an edge of weight ∞ if and only if (p, q) ∈ C.

In this example, bid generator 110 is configured to round the fractional solution to relationship (4) to an integral solution (e.g., V′, W′, Z′, Y′), as represented by the following relationships (5)-(8).

For every query s ∈ S, set V′ₛ=1 with probability 1, and V′ₛ=0 otherwise. (5)

If V′ₛ=1, set W′ₛ^{p}=0 for all p ∈ E. Otherwise, for each s ∈ S, and for all p* ∈ E, choose p* with probability proportional to W′^{p}ₛ(1∈) (e.g., for an appropriately small constant ∈) and set W′ₛ^{p}=1. Set W′ₛ^{p}=0, when p≠p*. (6)

For each p ∈ E and s ∈ S, set Z′ₛ^{p}=Σ_{t∈E, t≦p} W′ₛ^{t}. (7)

For any q ∈ Q\S,Y′_{q}=1 if and only if Z′ₛ^{c(q)}=1 for some s ∈ S, such that s ∈ D(p) (or equivalently (s, q) ∈ C). (8)

Based on the foregoing rounded integral solution included in relationships (5)-(8), bid generator 110 is configured to generate a bidding strategy, including, e.g., utility bid 114. In an example, the bidding strategy includes determining utility bid 114 as an exact match bid in which b(s)=c(s) for any s ∈ S if R′ₛ=1 (e.g., with probability Rₛ) and determining utility bid 114 as a broad match bid of b(s)=p for query s ∈ S if W′ₛ^{p}=1, e.g., with probability W′^{p}ₛ(1−∈).

### §5.0 Budget Constraints

In an example, an advertiser may wish to determine utility bid 114 for query 112 given a budget constraint B such that the total cost of a bidding strategy for the advertiser does not exceed the budget constraint B. Bid generator 110 is configured to increase the utility of the advertiser's bidding strategy, relative to the advertiser's utility of winning other queries, and given the budget constraint B.

In this example, bid generator 110 may also be configured to implement a LP to determine utility bid 114 given the budget constraint B, as represented in relationship (9).

$$\begin{matrix}Budgeted - LP & ⋮ & max {\sum }_{{q}_{i} ∈ Q} {X}_{{q}_{i}} v ( {q}_{i} ) n ( {q}_{i} ) \\ For every pair ( {q}_{j} , {q}_{i} ) ∈ C & ⋮ & \begin{matrix}{X}_{{q}_{i}} - {X}_{{q}_{j}} \geq 0 \\ {\sum }_{{q}_{i} ∈ Q} {X}_{{q}_{i}} c ( {q}_{i} ) n ( {q}_{i} ) \leq B\end{matrix} \\ ∀ {q}_{i} ∈ Q & ⋮ & 0 \leq {X}_{{q}_{i}} \leq 1\end{matrix} \qquad ( 9 )$$

Using relationship (9) and in the query language model, bid generator 110 is configured to execute a polynomial-time relationship to compute two budget-constrained advertisement campaigns that implement a utility bidding strategy to promote an increased utility for advertiser 104 given a budget constraint B. In an example, the polynomial-time relationship is represented by relationship (10).
1. Solve relationship (9) and compute an optimal solution X* such that X*_{q}_{ᵢ} ∈ {0, 1, X} for all queries qᵢ.
2. Let S₀ and S₁ be the sets of queries with the corresponding integral variables X*_{q}_{ᵢ}=0 and X*_{q}_{ᵢ}=1, respectively.

3. Let B₁=Σ_{q}_{ᵢ}_{∈S}₁ X*_{q}_{ᵢ}c(q)n(qᵢ₎ (10)
4. Run the following two advertisement campaigns:
   (a) A campaign with budget B₁ on queries in S₁.
   (b) A campaign with budget B−B₁ on queries in Q\(S₀∪S₁).

Using relationship (10), bid generator 110 is configured to generate utility bid 114 for query 112 using two-budget constrained advertisement campaigns. Utility bid 114 increases expected value (e.g., Σ_{q}(v(q)n(q))) for wining a set of queries relative to the advertiser's utility of winning other queries, subject to the condition that the expected spend (e.g., c(q)n(q)) does not exceed the budget constraint B.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, from an advertiser, a plurality of targeting criteria, with each of the targeting criteria at least partly specifying a keyword selected by the advertiser;
accessing, based on the plurality of targeting criteria, a set of keywords, with the set of keywords including base keywords that are derived from the targeting criteria and variation keywords that are derived from the base keywords;
for each keyword in the set of keywords:
retrieving a value for the advertiser of an advertisement click-through of an advertisement that is displayed in response to a query that includes the keyword;
retrieving a cost for a click-through of the advertisement;
retrieving an expected number of views of the advertisement; and
generating a utility score for the keyword, the utility score at least partly based on the value of the advertisement, the cost for the click-through of the advertisement, and the expected number of views of the advertisement;
determining, based on the utility scores of the set of keywords, a proper subset of the keywords that increases the advertiser's utility relative to the advertiser's utility for the set of keywords; and
generating utility bids for each of the keywords in the subset, each utility bid corresponding to one of the keywords in the subset and being a bid price for the keyword.

2. The method of claim 1, further comprising:
receiving, from the advertiser, a budget;
for each keyword in the set of keywords:
determining a cumulative cost value according to the cost of the click-through of the advertisement and the expected number of views of the advertisement; and
generating the utility bids such that an aggregation of cumulative cost values for the subset of the keywords is less than the budget.

3. The method of claim 1, wherein the query is a search query and the utility bid is a bid price for an advertisement slot displayed following the search query.

4. The method of claim 1, wherein the increased utility of the advertiser is a maximized utility of the advertiser.

5. The method of claim 1, wherein the utility bid equals the cost per click of the query.

6. The method of claim 1, wherein the set of keywords is at least partly defined based on a bidding language, with the bidding language specifying whether the set of keywords comprises a complete set of keywords in the advertisement auction or a subset of the keywords in the advertisement auction.

7. The method of claim 1, wherein determining the subset of the keywords that increases the utility of the advertiser comprises:
generating an approximation of the utility of the advertiser for the subset of keywords; and
determining that the subset of keywords increases the utility of the advertiser.

8. A computer-implemented method for setting bids on queries in a broad match auction, the method comprising:
receiving, from an advertiser, a set of queries;
accessing a linear program, with a fractional solution of the linear program being the same as an integral solution of the linear program;
determining the fractional solution of the linear program;
determining, based on the fractional solution of the linear program, a proper subset of the queries that increases the advertiser's utility relative to the advertiser's utility for the set of queries; and
generating utility bids for each of the queries in the subset, each utility bid corresponding to one of the queries in the subset and being a bid price for the query.

9. The computer-implemented method of claim 8, wherein determining the fractional solution of the linear program comprises:
generating, from the set of queries, a weighted flow graph comprising a plurality of vertices and a plurality of edges, with at least some of the vertices corresponding to a query in the set of queries, with each of the edges corresponding to a weighed value score for two vertices, with one of the vertices in the plurality of vertices comprising a source node that is connected to other vertices having a first pre-defined edge weight, and with another one of the vertices in the plurality of vertices comprising a target node that is connected to other vertices having a second pre-defined edge weight; and
partitioning the graph into two sides, with one side of the graph including the source node and with another side of the graph including the target node, and with the side of the graph comprising the target node including the proper subset of queries that increases the advertiser's utility relative to the advertiser's utility for the set of queries

10. A computer-implemented method for setting bids on keywords in a broad match auction, the method comprising:
receiving, from an advertiser, a set of keywords;
accessing a linear program for a keyword language auction;
determining a solution to the linear program;
determining, based on the solution to the linear program, a proper subset of the keywords that increases the advertiser's utility relative to the advertiser's utility for the set of keywords; and
generating utility bids for each of the keywords in the subset, each utility bid corresponding to one of the keywords in the subset and being a bid price for the keywords.

11. The computer-implemented method of claim 10, wherein the solution comprises a fractional solution, and wherein determining the proper subset of the keywords is at least partly based on rounding the fractional solution to an integral solution in accordance with a probability of the fractional solution being an integer.

12. One or more machine-readable media configured to store instructions that are executable by one or more processing devices to perform functions comprising:
receiving, from an advertiser, a plurality of targeting criteria, with each of the targeting criteria at least partly specifying a keyword selected by the advertiser;
accessing, based on the plurality of targeting criteria, a set of keywords, with the set of keywords including base keywords that are derived from the targeting criteria and variation keywords that are derived from the base keywords;
for each keyword in the set of keywords:
retrieving a value for the advertiser of an advertisement click-through of an advertisement that is displayed in response to a query that includes the keyword;
retrieving a cost for a click-through of the advertisement;
retrieving an expected number of views of the advertisement; and
generating a utility score for the keyword, the utility score at least partly based on the value of the advertisement, the cost for the click-through of the advertisement, and the expected number of views of the advertisement;
determining, based on the utility scores of the set of keywords, a proper subset of the keywords that increases the advertiser's utility relative to the advertiser's utility for the set of keywords; and
generating utility bids for each of the keywords in the subset, each utility bid corresponding to one of the keywords in the subset and being a bid price for the keyword.

13. The one or more machine-readable media of claim 12, wherein the functions further comprise:
receiving, from the advertiser, a budget;
for each keyword in the set of keywords:
determining a cumulative cost value according to the cost of the click-through of the advertisement and the expected number of views of the advertisement; and
generating the utility bids such that an aggregation of cumulative cost values for the subset of the keywords is less than the budget.

14. The one or more machine-readable media of claim 12, wherein the query is a search query and the utility bid is a bid price for an advertisement slot displayed following the search query.

15. The one or more machine-readable media of claim 12, wherein the increased utility of the advertiser is a maximized utility of the advertiser.

16. The one or more machine-readable media of claim 12, wherein the utility bid equals the cost per click of the query.

17. An electronic system comprising:
one or more processing devices; and
one or more machine-readable media configured to store instructions that are executable by the one or more processing devices to perform functions comprising:
receiving, from an advertiser, a plurality of targeting criteria, with each of the targeting criteria at least partly specifying a keyword selected by the advertiser;
accessing, based on the plurality of targeting criteria, a set of keywords, with the set of keywords including base keywords that are derived from the targeting criteria and variation keywords that are derived from the base keywords;
for each keyword in the set of keywords:
retrieving a value for the advertiser of an advertisement click-through of an advertisement that is displayed in response to a query that includes the keyword;
retrieving a cost for a click-through of the advertisement;
retrieving an expected number of views of the advertisement; and
generating a utility score for the keyword, the utility score at least partly based on the value of the advertisement, the cost for the click-through of the advertisement, and the expected number of views of the advertisement;
determining, based on the utility scores of the set of keywords, a proper subset of the keywords that increases the advertiser's utility relative to the advertiser's utility for the set of keywords; and
generating utility bids for each of the keywords in the subset, each utility bid corresponding to one of the keywords in the subset and being a bid price for the keyword.

18. The electronic system of claim 17, wherein the functions further comprise:
receiving, from the advertiser, a budget;
for each keyword in the set of keywords:
determining a cumulative cost value according to the cost of the click-through of the advertisement and the expected number of views of the advertisement; and
generating the utility bids such that an aggregation of cumulative cost values for the subset of the keywords is less than the budget.

19. The electronic system of claim 17, wherein the query is a search query and the utility bid is a bid price for an advertisement slot displayed following the search query.

20. The electronic system of claim 17, wherein the increased utility of the advertiser is a maximized utility of the advertiser.

21. An electronic system comprising:
means for receiving, from an advertiser, a plurality of targeting criteria, with each of the targeting criteria at least partly specifying a keyword selected by the advertiser;
means for accessing, based on the plurality of targeting criteria, a set of keywords, with the set of keywords including base keywords that are derived from the targeting criteria and variation keywords that are derived from the base keywords;
for each keyword in the set of keywords:
means for retrieving a value for the advertiser of an advertisement click-through of an advertisement that is displayed in response to a query that includes the keyword;
means for retrieving a cost for a click-through of the advertisement;
means for retrieving an expected number of views of the advertisement; and
means for generating a utility score for the keyword, the utility score at least partly based on the value of the advertisement, the cost for the click-through of the advertisement, and the expected number of views of the advertisement;
means for determining, based on the utility scores of the set of keywords, a proper subset of the keywords that increases the advertiser's utility relative to the advertiser's utility for the set of keywords; and
means for generating utility bids for each of the keywords in the subset, each utility bid corresponding to one of the keywords in the subset and being a bid price for the keyword.
